(19) United States
(12) Patent Application Publication
(10) Pub. No.: US 2004/0107413 A1
(43) Pub. Date: Jun. 3, 2004

(54) Autism treatment system and method

(76) Inventor: John D. Bixler, Johnstown, PA (US)

Correspondence Address: Richard C. Litman, LITMAN LAW OFFICES, LTD., P.O. Box 15035, Arlington, VA, 22215, US

(21) Appl. No.: 10/718,566

(22) Filed: Nov. 24, 2003

Related U.S. Application Data
(60) Provisional application No. 60/428,259, filed on Nov. 22, 2002.

(51) Int. Cl. G06F 9/44

(52) U.S. Cl. 717/100

(57) ABSTRACT

An autism treatment system and method whereby a patient is evaluated to ascertain the patient=s strengths in at least five core developmental domains. The evaluations are input into a computer running a specially designed program. The program outputs a ranking of the domains according to the patient's level of functionality in each domain. Each of these levels of functionality is individually broken down into a plurality of sub-levels and the relative development or each sub-level is then graphically displayed. Suggested treatment plan topics follow the sub-levels.

### CROSS-REFERENCE TO RELATED APPLICATION

This application claims the benefit of U.S. Provisional Patent Application Serial No. 60/428,259, filed Nov. 22, 2002.

### BACKGROUND OF THE INVENTION

1. Field of the Invention

The present invention relates to autism treatment, in particular to a system and method for developing a treatment plan for autistic patients. The system and method include the use of computer software to aid the therapist in developing a treatment plan.

2. Description of the Related Art

Traditional treatments for autism take three broad forms: pharmaceutical medication, behavioral modification, and developmental/relational treatment. None of these approaches has been more than marginally successful. For example, behavior modification alone cannot succeed because it concentrates on external rewards and specific behaviors. When the child is on his or her own, and no one rewards the child for improved behavior, the behavioral improvement can wither. Behavior modification also fails because many autistic children cannot generalize.

A developmental method, in contrast, focuses on skills needed to generalize responses. For example, in addressing the needs of a child who did not comprehend the rules of traffic intersections, the therapist played with the child on a rug on which were depicted streets, intersections, and stop signs. Toy people represented the child, passers by, and traffic guards or police. The child moved the toy representing himself around the streets and learned to stop at intersections and wait for instructions from any guard.

Developmental approaches focus on developmental levels as clusters of skills typically needed to move on to another level of development. For example, the fine motor skills in the mouth and tongue need to be mastered in order to speak. Children often develop certain sounds such as “ma-ma” early, and, as their ability increases, they are able to use more complex words. These clusters of skills and deficits alert the developmental counselor to the child's level of functioning. Treatment is driven by assisting the child to increase skills and resources needed in order to move on to the next level of development.

The strengths of this approach include a broader picture of the child's needs and skills, ability for the child to relate to others, and the development of new skills that can be generalized to cover other situations. Drawbacks typically include greater difficulty in measuring progress in scientific terms, and slower changes in specific behaviors, because the behaviors are rarely targeted directly. The instant invention overcomes these difficulties by carefully baselining initial abilities and measuring progress against specific goals.

U.S. Pat. No. 6,234,979, issued May 22, 2001 to Michael M. Merzenich, provides a method and apparatus for a training regimen that alleviates exaggerated sensory, perceptual, cognitive, and/or emotional responses. The invention focuses on habituating individuals to sensory perceptions to which they are extraordinarily sensitive. It includes only one method of treating autism. It does not emphasize developmental/relational treatment, includes no developmental-and-needs-assessment device, includes no child's strengths checklist, incorporates no family-structure-and-values questionnaire, possesses no decision tree, and does not have an exhaustive treatment-plan template.

U.S. Pat. No. 5,722,418, issued Mar. 3, 1998 to L. William Bro, discloses a method for mediating a social and behavioral influence process through an interactive telecommunications guidance system. The invention is a system for sending robotic, computer-generated, motivational messages and questions to patients. It includes none of the proven methods of treating autism and none of the features of the instant invention.

U.S. Pat. No. 5,008,251, issued Apr. 16, 1991 to Harry E. Gruber, discloses a method of treating autism by administering purine nucleoside and purine nucleoside-related analogs, both of which increase extracellular adenosine concentration. The Gruber patent teaches drug treatment to address autism, but does not teach a developmental/relational treatment approach.

U.S. Pat. No. 6,056,549, issued May 2, 2000 to Chari Fletcher, discloses a communication and teaching aid for increasing the communication skills of nonverbal, speech and/or language impaired individuals, comprising a collection of displays of numbers, words, and pictures. The invention uses only one form of treatment for only one manifestation of autism. It is not a comprehensive, scientific treatment method, such as the present invention.

U.S. Pat. No. 6,187,309, issued Feb. 13, 2001 to McMichael et al., discloses a method of treating autism by administering anti-rubeola antibody. The invention relies only on drug treatment.

None of the above inventions and patents, taken either singly or in combination, is seen to describe the instant invention as claimed. Thus an autism treatment system and method solving the aforementioned problems is desired.

### SUMMARY OF THE INVENTION

The present invention is a system and method for developing a treatment plan for autistic patients. The method involves first observing the patient in his home environment in order to develop a profile of the patient's strengths and to measure the patient=s abilities in five core domain areas. The information is entered into a computer, and through the use of software, the computer outputs a graphical and textual assessment profile of the child. The assessment profile includes dangerousness issues that should be addressed. The program further breaks down developmental needs in five core domains, including Emotional Development, Cognitive Development, Relational-Social Development, Play Development, and Dangerousness, and further divides each domain into sub-categories and displays the patient's abilities in each sub-category, suggesting percentages of therapy time to be spent on each core domain.

The program then displays a minimum list of topics which should be addressed in a treatment plan based on the aforementioned sub-categories. The program also refers the user to additional materials further explaining these topics. The computer will also display any relevant safety concerns, and any relevant weakness and/or strength the patient has that may be helpful to consider when creating a treatment plan. The program additionally displays any treatment techniques which have been used in similar situations in the past. The user is then prompted to enter a proposed treatment plan.

The patient will be periodically reassessed with the new information being entered into the computer as disclosed above. This process may be repeated for the length of the treatment. The computer will also generate a comparison chart showing the changes in the domains over time.

Accordingly, it is a principal object of the invention to provide an automated method of developing a treatment plan for autism.

It is a further object of the invention to provide a system for tracking the progress of autistic patients.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a sample chart of patient strengths.

FIG. 2 is a screen shot of the password screen.

FIG. 3 is a screen shot of the Clients folder.

FIG. 4 is a screen shot of the Client General Information folder.

FIG. 5 is a screen shot of the Dangerousness Issues folder.

FIG. 6 is a screen shot of the Play Development folder.

FIG. 7 is a screen shot of the Family Values folder.

FIG. 8 is a screen shot of the Assessments folder.

FIG. 9 is a screen shot of the Treatment Plan Approach Summary folder.

FIG. 10A is a representative screen shot of the Treatment Plan folder page.

FIG. 10B is a continuation of the Treatment Plan folder page of FIG. 10A.

FIG. 10C is a representative screen shot of a Crisis Intervention folder page.

FIG. 11A is a representative example of a competency graph for cognitive development Level 1.

FIG. 11B is a representative example of a competency graph for cognitive development Level 2.

FIG. 11C is a representative example of a competency graph for cognitive development Level 3.

FIG. 12 is a representative chronological treatment progress comparison graph for the five core domains for a selected patient.

FIG. 13 is a screen shot of a representative Global Domain Graph from the Assessment folder.

FIG. 14 is a screen shot of a representative Emotional Development page from the Assessment folder.

FIG. 15 is a screen shot of a representative Treatment Plan Approach Summary page.

FIG. 16 is a screen shot of a representative dialog box showing a Domain Average Summary report.

FIG. 17 is a screen shot of a representative Crisis Intervention Plan page.

FIG. 18 is a screen shot of a representative treatment plan signature page.

FIG. 19 is a screen shot off a representative Aggressiveness Issues page from the Questions folder.

FIG. 20 is a screen shot of a representative print view of a Treatment Plan.

FIG. 21 is a screen shot of a representative print view of a Crisis Intervention Plan.

FIG. 22 is a screen shot of a representative print view of a Treatment Plan Signature page.

FIGS. 23A and 23B are charts summarizing access to the various input forms and output reports through the folder tabs.

FIGS. 24A and 24B is a flowchart showing the flow through the software program for developing a treatment plan for autistic patients according to the present invention.

Similar reference characters denote corresponding features consistently throughout the attached drawings.

### DETAILED DESCRIPTION OF THE PREFERRED EMBODIMENT

The present invention is a system and method for the treatment of autism. The method involves the coordination of a number of different care providers in a manner which efficiently uses healthcare resources to most effectively treat autistic patients.

Once the patient has been diagnosed as autistic, a Child and Adolescent Special Services Program (CASSP) meeting is conducted, at which time wrap-around serves are recommended. An agency is assigned to work with the patient, and a behavioral specialist consultant (BSC) and a member of the therapeutic support staff (TSS) are assigned.

The present invention makes extensive use of a behavioral specialist consultant (BSC). The medical assistance definition of a BSC is one who, in collaboration with other members of the treatment team, designs and directs the implementation of a behavior modification intervention plan which is individualized to each patient and to the family needs. The role played by a BSC is a complex and varied one that is defined far differently than the traditional roles of therapist or counselor. The BSC is a role that requires the specialist to consult across multiple settings, recognizing the strengths and limitations within each setting, and making suggestions regarding the behavioral needs of the child.

The BSC first meets with the family of the patient to establish a rapport with the family and conduct an assessment of the patient. The assessment involves direct observations of the patient in the patient's natural environment, which most commonly is the patient's home. Before conducting an assessment the BSC should first determine what the goals and expectations of the patient's family's are. All recommendations and assessments should be made with these goals and expectations in mind.

The purpose of the assessment is to uncover a patient=s strengths as well as the developmental needs of the patient. The developmental needs are divided into a plurality of developmental domains. There are five core domains which are essential to the system. These core domains are: Emotional Development, Cognitive Development, Relational-Social Development, Play Development and Dangerousness. While the core domains are essential, a skilled psychologist may add additional domains to further expand the assessment.

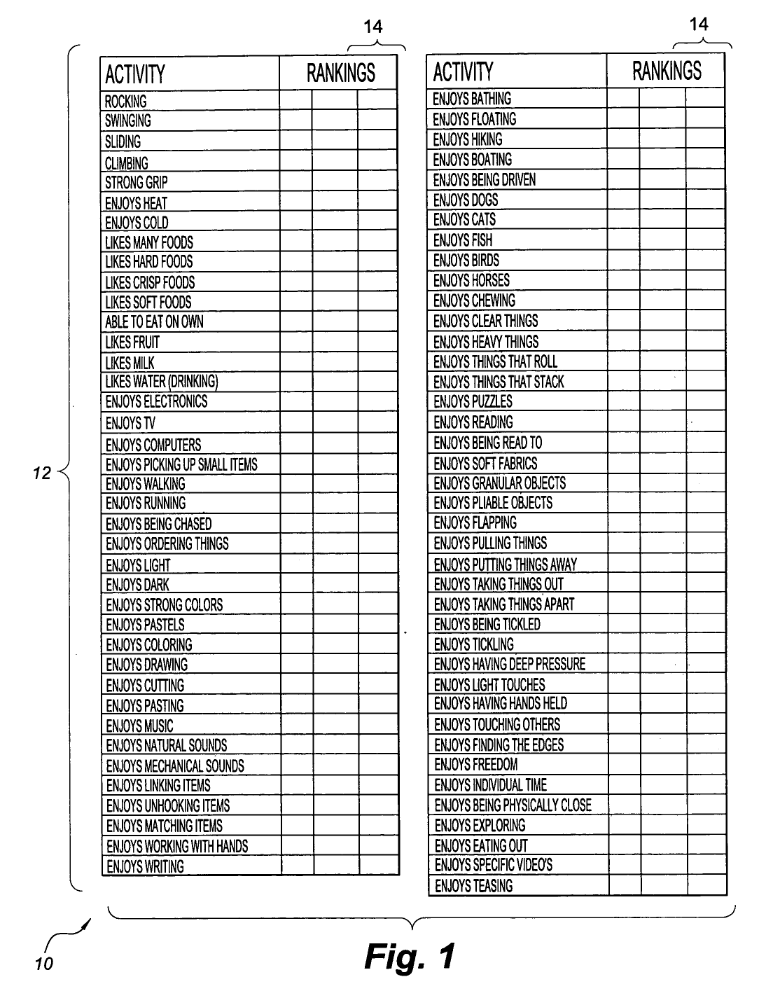

One method of determining the strengths of a patient is to use an assessment device similar to the checklist 10 shown in FIG. 1. This checklist 10 lists a plurality of activities 12 such as rocking, climbing and swimming. Next to the activities is a column 14 where the BSC ranks the activity. Preferably, the activity is ranked with whole numbers ranging from 0 and 6, with 0 representing the lowest score (no ability) and 6 representing the highest possible score (highest ability). The ranking system could be easily modified by a skilled practitioner.

The BSC fills out the columns from direct observations of the child, and in so doing determines the patient=s strengths. The compiled activities 12 are meant to be representative only, and it is within the abilities of one skilled in the art to alter the list.

The BSC then uses a second group of assessment devices to determine the developmental needs of the patient. The assessment devices consist of a variety of questions designed to gauge the patient's functionality in each core domain. The answers to the questions are rated, ordinarily with whole numbers from 0 to 6 with 0 being the lowest score (never) and 6 being the highest score (always seems able).

Table 1 shows a representative sample of questions used to assess emotional development.

TABLE 1

| | |
|---|---|
| Emotional Development | Rating |

| | |
|---|---|
| 1 | Child is able to maintain eye contact |
| 2 | Child responds to touch |
| 3 | Child responds by turning his/her head towards |
| | his/her parent when his/her name is called by |
| | parent |
| 4 | Child smiles/acknowledges presence of caregiver |
| 5 | Child moves toward caregiver when child enters |
| | room |
| 6 | Child cries when sad |
| 7 | Child yells when angry |
| 8 | Child bites when angry |
| 9 | Child grabs hair when angry |
| 10 | Child kicks when angry |
| 11 | Child is able to sooth self when angry |
| 12 | Child is able to sooth self when sad |
| 13 | Child is able to be soothed by others when angry |
| 14 | Child can symbolically/verbally communicate |
| | feelings of happiness |
| 15 | Child can symbolically/verbally communicate |
| | feelings of sadness |
| 16 | Child can symbolically/verbally communicate |
| | feelings of anger |
| 17 | Child's moods are stable across the better part of |
| | the day |

Table 2 shows a representative sample of questions used to assess cognitive development.

TABLE 2

| | |
|---|---|
| Cognitive Development | Rating |

| | |
|---|---|
| 1 | Child uses Icon schedules |
| 2 | Child is able to perform daily tasks without |
| | specific step-by-step prompting. |
| 3 | Child uses icons schedules that are task specific |
| 4 | Child can use flexible schedules |
| 5 | Child can use written schedules |
| 6 | Child is able to use a date book |
| 7 | Child is able to read digital time |
| 8 | Child is able to read analogue time by the hour |
| 9 | Child is able to read analogue time by the |
| | quarter hour |
| 10 | Child is able to read analogue time by the minute |
| 11 | Child understands the difference between weekdays |
| | and weekends |
| 12 | Child is able to understand days of the week |
| 13 | Child is able to use a calendar |
| 14 | Child understands months |
| 15 | Child awakens at approximately the same time each |
| | day (weekday) |
| 16 | Child awakens at approximately the same time each |
| | day (weekend) |
| 17 | Child sleeps through the night |

Table 3 shows a representative sample of questions used to assess relational-social skills.

TABLE 3

| | |
|---|---|
| Relational-Social Skills Development | Rating |

| | |
|---|---|
| 1 | Child visually tracks moving objects |
| 2 | Child reaches for novel toys |
| 3 | Child looks back when walking/crawling away from |
| | caregivers |
| 4 | Child leaves room/area where caregiver is without |
| | awareness of caregiver |
| 5 | Child returns and seeks interactions after an |
| | event |
| 6 | Child shows distress when parent leaves |
| | room/area/house |
| 7 | Child maintains interactions by smiling, talking, |
| | cooing, cuddling, etc. |
| 8 | Child ends interactions by fussing, becoming |
| | tense, crying, hitting, etc. |
| 9 | Child answers questions |
| 10 | Child asks questions |
| 11 | Child is able to generate 2^{nd} level of response |
| | based on answer to question to continue a |
| | dialogue one more round |
| 12 | Child is able to maintain a give and take |
| | conversation where the topic changes as a result |
| | of new information |
| 13 | Child is able to maintain a give a take |
| | conversation around a topic of their choosing |
| 14 | Child is able to maintain conversation when new |
| | topics are introduced |
| 15 | Can identify feeling faces on a chart or in |
| | pictures |
| 16 | Child is able to read basic body language |
| 17 | Child is able to understand complex culturally |
| | appropriate body language |

Table 4 shows a representative sample of questions used to assess play development.

TABLE 4

| | |
|---|---|
| Play Development | Rating |

| | |
|---|---|
| 1 | Child plays with a toy to self stimulate |
| 2 | Child uses repetitive motor manipulation to play |
| 3 | Child plays with a single toy within its function |
| | w/o elaboration |
| 4 | Child plays with more than one toy interactively |
| | in a coordinated fashion |
| 5 | Child symbolically uses object as a toy |
| 6 | Child creates interactive imaginative play with |
| | toys |
| 7 | Child plays with a variety of toys |
| 8 | Child re-enacts common family activities |
| 9 | Child uses pure imagination |
| 10 | Child is able to play when modeling has occurred |
| | one-on-one |
| 11 | Child is able to participate in play based on |
| | group modeling |
| 12 | Child is able to play with encouragement |
| 13 | Child generates play on own |
| 14 | Child can play imaginatively |
| 15 | Child is able to engage in parallel play with |
| | children |
| 16 | Child is able to engage in dramatic play with 2 |
| | steps |
| 17 | Child is able to engage in dramatic play with 3 |
| | or more steps |

Table 5 shows a representative sample of questions used to assess dangerousness and danger awareness.

TABLE 5

| | |
|---|---|
| Danger Awareness, Dangerousness Issues | Rating |

| | |
|---|---|
| 1 | Child shows an awareness of visual cliffs and |
| | stops when unable to negotiate |
| 2 | Child climbs only on appropriate things |
| 3 | Child shows awareness of moving cars or other such |
| | dangers |
| 4 | Child stops at the side of the street and waits |
| | for someone to cross with |
| 5 | Child stops and looks for oncoming traffic before |
| | crossing the street with assistance |
| 6 | Child stops and looks for oncoming traffic before |
| | crossing the street without assistance |
| 7 | Child demonstrates an understanding of traffic |
| | signals |
| 8 | Child demonstrates an understanding of crosswalks |
| 9 | Child stops when his/her name is called by |
| | caregiver in public setting |
| 10 | Child does not leave house without permission |
| 11 | Child knows how to lock, unlock and open doors and |
| | windows |
| 12 | Child only opens cabinets in the house that are |
| | safe for him/her |
| 13 | Child is aware of the danger of stoves and other |
| | potentially dangerous household appliances |
| 14 | Child knows not to use household appliances in a |
| | safe manner |
| 15 | Child responds to how surfaces by moving away |
| 16 | Child is able to identify smoke and when it is |
| | safe |
| 17 | Child enters water that is too deep for him/her |

Table 6 shows a representative sample of questions used to assess aggressiveness issues.

TABLE 6

| | |
|---|---|
| Aggressiveness Issues | Rating |

| | |
|---|---|
| 1 | Child head-bangs or hits self with hands or feet |
| 2 | Child breaks own skin by biting |
| 3 | Child breaks own skin by picking |
| 4 | Child breaks own skin by using object |
| 5 | Child bruises self by biting |
| 6 | Child bruises self by pinching |
| 7 | Child bruises self with objects |
| 8 | Child head-butts others |
| 9 | Child bites others and breaks skin or bruises |
| 10 | Child scratches or pinches others to the point of |
| | drawing blood or bruises |
| 11 | Child breaks objects for no apparent reason |
| 12 | Child breaks objects when agitated |
| 13 | Child targets specific objects to break when |
| | agitated |

Each of the above tables represents assessment devices which are shown as examples only, and are not intended to limit the scope of the invention. A skilled practitioner could easily modify and/or add additional questions to each of the domains so long as the questions function to explore a patient's competency in the given domain area.

The information gathered concerning the patient's strengths and core domains is preferably entered into a computer. The computer typically has a processor, RAM, and ROM. The computer ROM contains a spreadsheet or database type program which is configured to display charts similar to the assessment devices detailed above. It also contains information for a plurality of patients. The user enters data into the program using a mouse or the computer's keyboard. The program will be described by reference to representative screen shots. It will be understood that the screen presentation, or layout of particular pages, including such formal matters as the menu bar, client of patient identification data on particular pages, graph format, etc., may vary from time to time within the scope of the present invention.

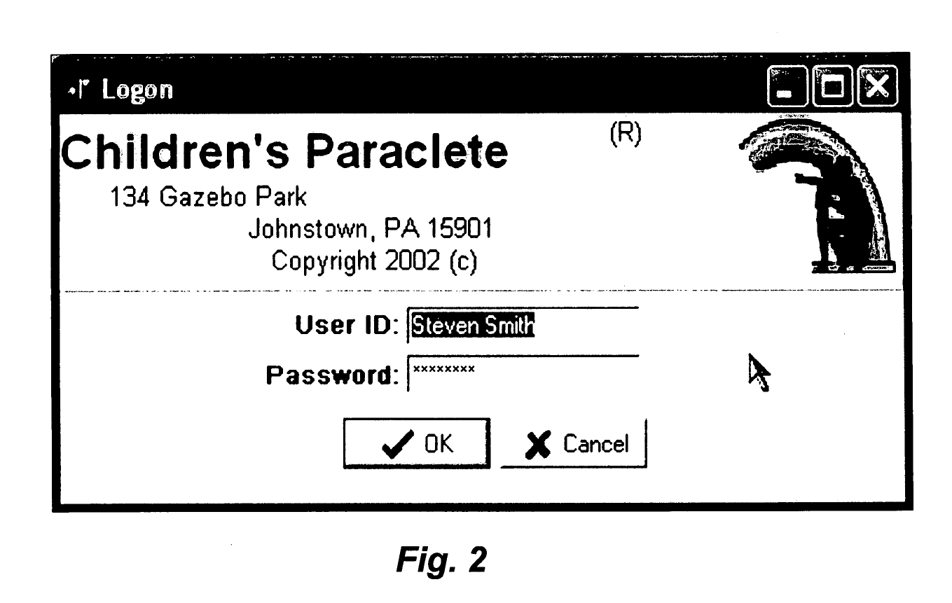

Access to the program is protected by a conventional user name-password system. When entering information, the user first must enter a user ID and a password. FIG. 2 shows a typical ID and password screen. If the ID and password are validated as an authorized user, the program proceeds to an index or catalog window having a variety of option folder tabs and the associated folders. The folder tab approach provides an intuitive user interface to organizing client data by analogy to conventional paper files

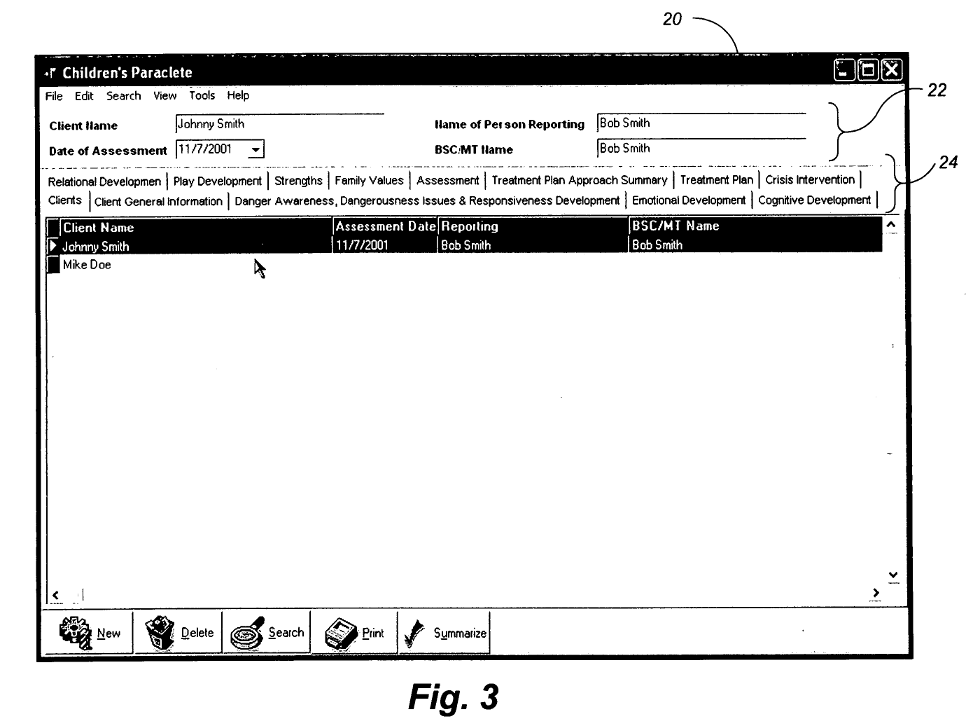

FIG. 3 is a screen shot of the index or catalog window 20, which appears under the “Clients” folder tab. In addition to a standard menu bar at the top of the screen and a taskbar at the bottom of the screen, the window 20 preferably has an identification bar 22 showing the client/patient's name, the date and the name of the BSC providing the report for the selected client file. The index or catalog window 20 further has a folder tab bar 24 containing a plurality of folder tabs which may be selected by the user. As a default, the Clients folder tab and its associated folder will be selected initially. The screen presents a scrollable list of client files already recorded in the system. This allows the user to either select a client already in the system, or to add a new client to the system by selecting the “New” button from the task bar. Once a client has been selected or added the user may select any folder tab and add or edit the information contained in the associated folder. In the example shown in FIG. 3, the client file for “Johnny Smith” (a fictional example for purposes of illustration) is selected, as indicated by the highlighted entries in the scrollable window, and consequently the corresponding record entries for Johnny Smith are reflected in the identification bar 22.

The majority of screens presented by the program may have the same common layout illustrated in FIG. 3, i.e., from top to bottom, a title or caption bar; a menu bar; an identification bar 22 with edit boxes and/or combo boxes for display and user entry of data for selecting a particular client file; a file tab bar 24 with clickable tabs for selecting various records, forms or functions; a scrollable edit window for user data entry or non-editable list box for display of information; and a task bar with selected function buttons. A folder tab may be selected either by clicking on the tab, or by navigating to the tab with the keyboard using the ALT key (or other designated special function key) and pressing the ENTER key.

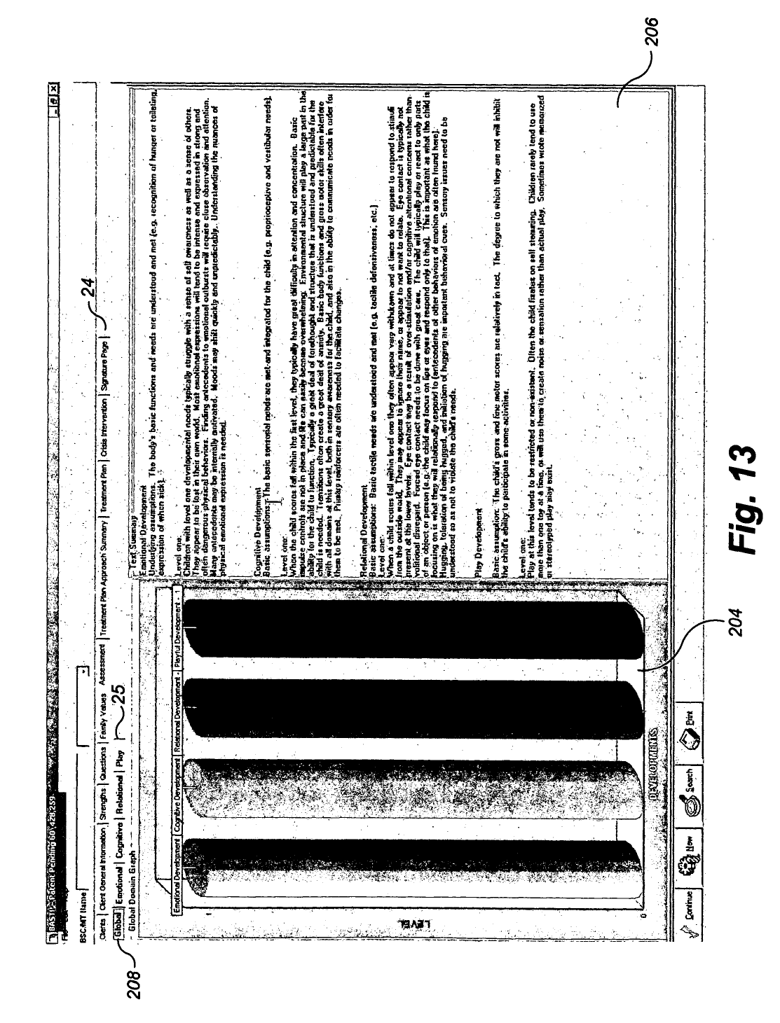

Alternatively, the screens may have the layout shown in FIG. 13, i.e., from top to bottom, a title or caption bar; a menu bar; file identification bar including a text box and combo box identifying the file by BSC name and file number; a file or folder tab bar 24 with clickable tabs for selecting various records, forms or functions; a sub-file or sub-folder tab bar 25 with clickable tabs for further selecting records, forms or functions; a scrollable edit window for user data entry or non-editable list box for display of information; and a task bar with selected function buttons.

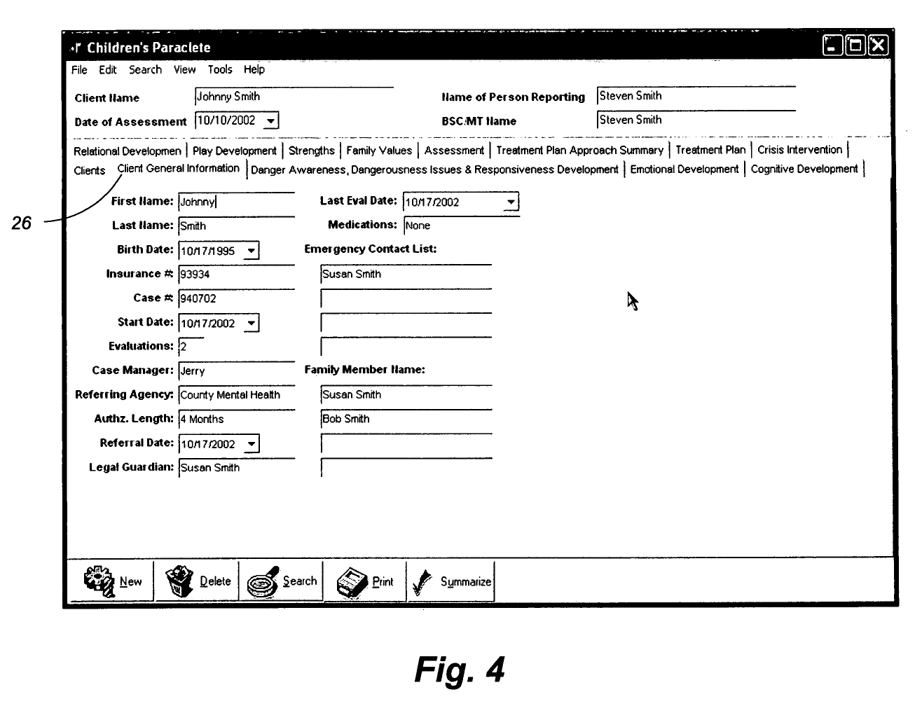

FIG. 4 shows a screen shot displaying the General Client Information folder page 26 for the client file selected from the index page 20. The folder page 26 contains general client information including the client=s name, date of birth, case manager, and emergency contacts in edit and combo boxes.

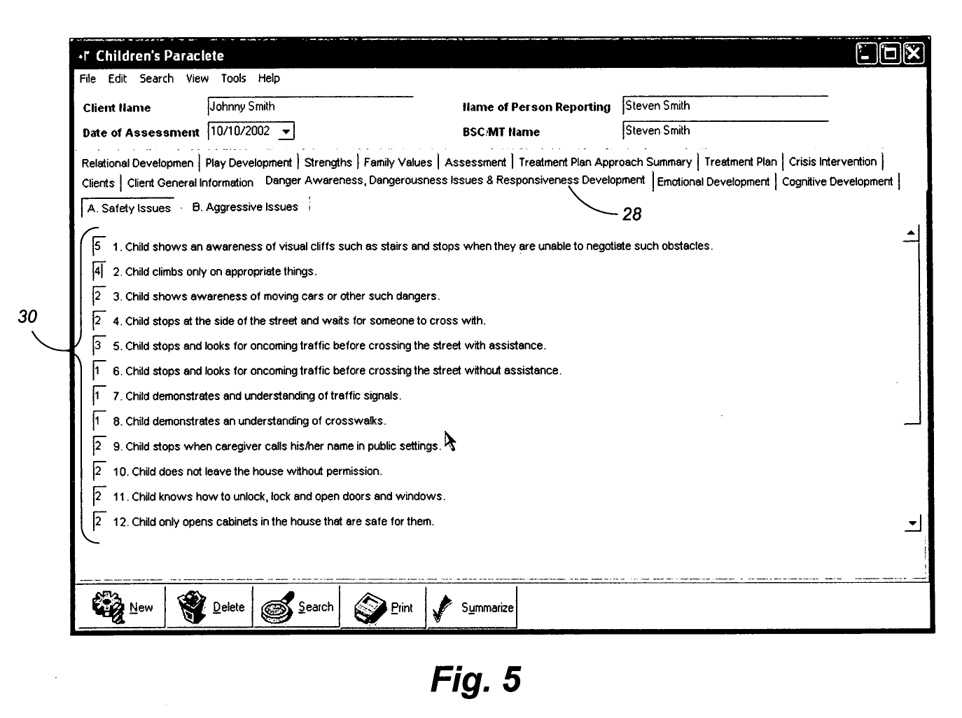

FIG. 5 shows a screen shot displaying the Dangerousness Issues & Responsiveness Development folder page 28. This folder preferably has two subsections A. Safety Issues and B. Aggressiveness Issues with the Safety Issues subsection being shown in FIG. 5. The user selects the desired subsection by selecting the appropriate subsection folder tab as described above. The user ranks each safety issue and places the ranking in one of the edit boxes 30 adjacent to the safety issue. It will be noted that the screen shot corresponds to the safety issues listed in Table 5, above.

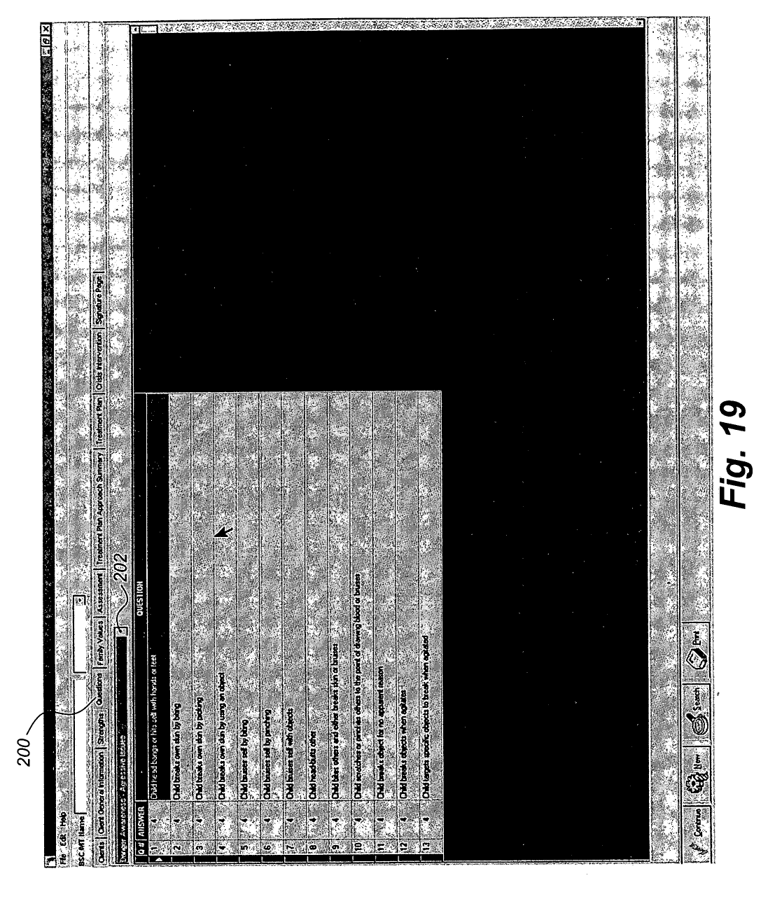

FIG. 19 shows an alternative format for the aggressiveness issues page. In this format the safety issues and the aggressiveness issues pages are stored in the Questions folder 200. The Questions folder 200 stores a number of forms to be filled out by the BSC. The appropriate form is selected from a drop down list box 202. The BSC fills out the aggressiveness issues form, together with a ranking for each issue listed on the form. It will be noted that the aggressiveness issues listed in the screen shot of FIG. 19 correspond to the issues listed in Table 6.

The Questions folder 200 also contains forms that the BSC fills out relative to the other core domain members of the second group of assessment devices, namely, the Emotional Development, Cognitive Development, Relational-Social Development, and Play Development factors listed above in Tables 1-4. These forms have a format similar to that show either in FIG. 19 if the Questions folder 200 format is used, or may have the format of FIG. 5 and be stored under their own folder tab, rather than in the Questions folder 200.

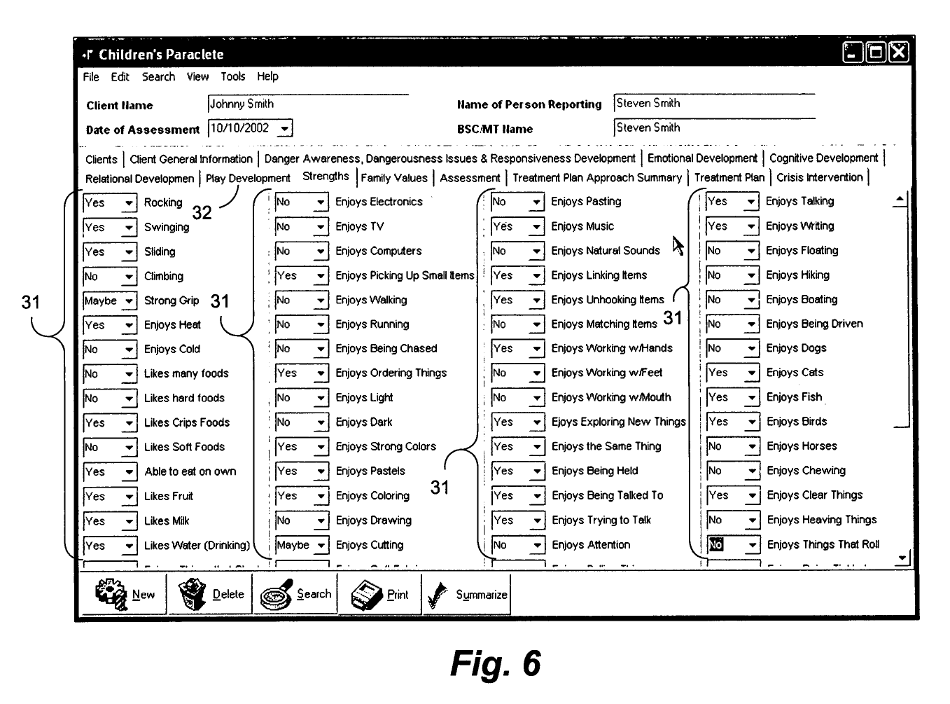

FIG. 6 shows a screen shot displaying the Strengths folder page 32. The user selects the appropriate response in the drop down list boxes 31 next to each listed strength to denote whether or not the client has the listed strength. It will be noted the strength list in the screen shot corresponds to the BSC questionnaire of FIG. 1.

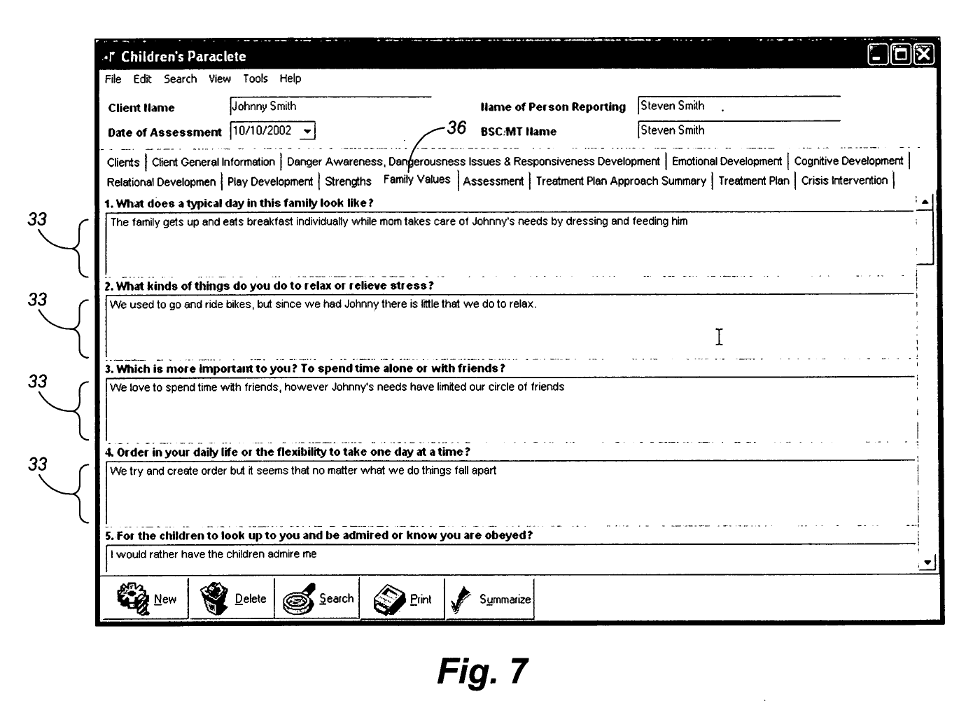

The Family Values section is slightly different than the core domain sections and strength lists in that the user must enter textual information into the edit boxes provided. FIG. 7 shows a screen shot displaying the Family Values folder 36 page with sample answers in the edit boxes 33.

The folders may be accessed and/or re-accessed in any order. Once the abovementioned core domain data has been entered, the user may then access the Assessment, Treatment Plan Approach Summary, Treatment Plan and Crisis Intervention sections. These sections are generated by the computer using the core domain data as well as information gathered from previous patients with similar symptoms.

For example, in the Assessment folder (discussed below) the computer outputs highly relevant dangerous issues. Dangerousness issues are scored from 0 (behavior does not often occur) to 6 (behavior occurs with great frequency). Higher numbers registered throughout the assessment devices generally denote more socially acceptable behaviors. However, some questions, such as questions 1 through 10 listed in the Aggressiveness Issues assessment section (Table 6), may be phrased so that more socially acceptable behaviors produce lower numbers. In these cases the computer will reverse the scores (e.g., 0 to 6, 2 to 4) input by the user so that more socially acceptable behaviors will result in higher scores.

The computer also outputs some instructions or cautions to the therapist concerning the less socially acceptable dangerousness issues. Typical instructions are: “The assessment profile suggests that the following dangerousness issues need to be carefully examined to insure the safety of the child. Treatment of the child must focus on maximizing risk factors. Further, splinter skills need to be noted so as not to assume safety.”

Following the instructions, the computer outputs any dangerous issues rated above four during the assessment process. The computer also outputs the text “Children with similar protocols tend to need close constant supervision” after any dangerous issues listed; such as breaking objects, or running into the street, which require such supervision.

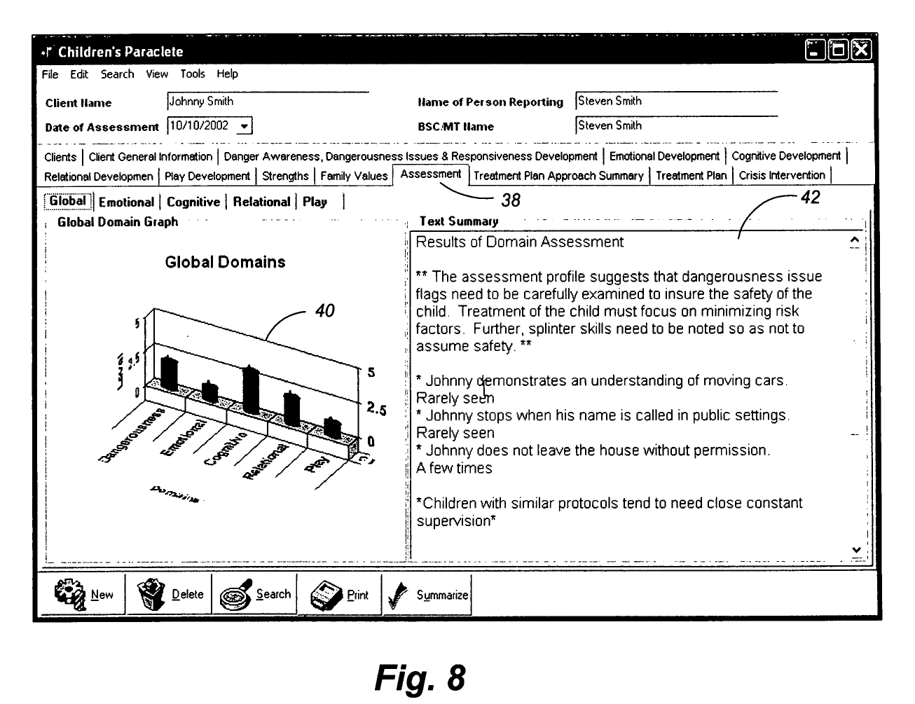

FIG. 8 shows a screen shot of a representative Assessment folder 38 page. The folder page 38 shows a graph of the core domains 40 and a results list box 42 listing the results of each domain assessment.

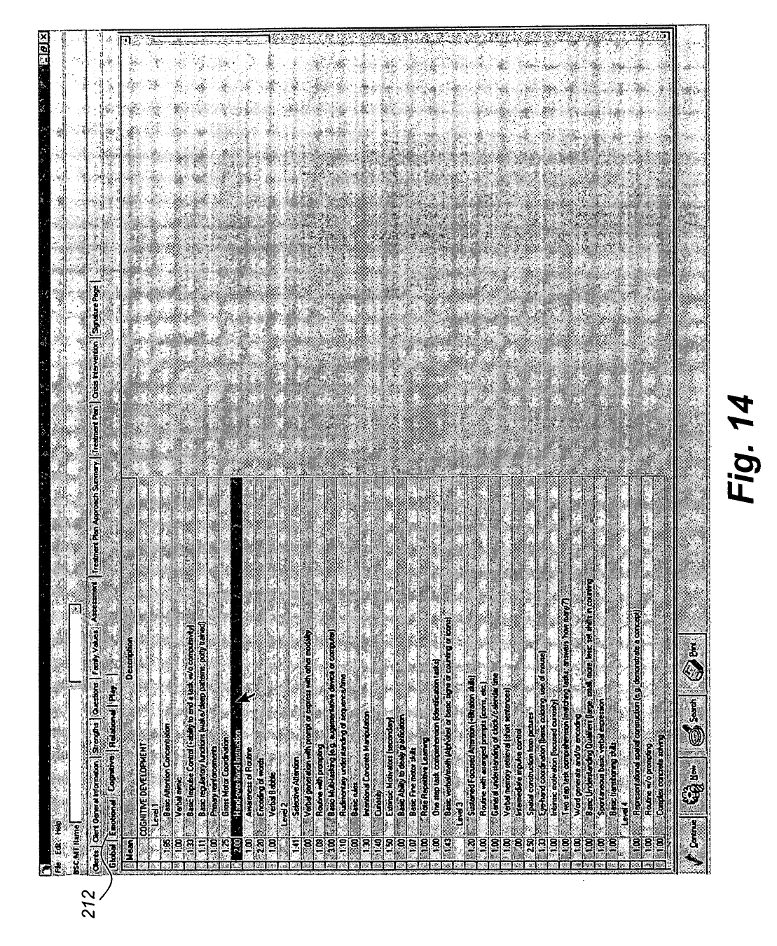

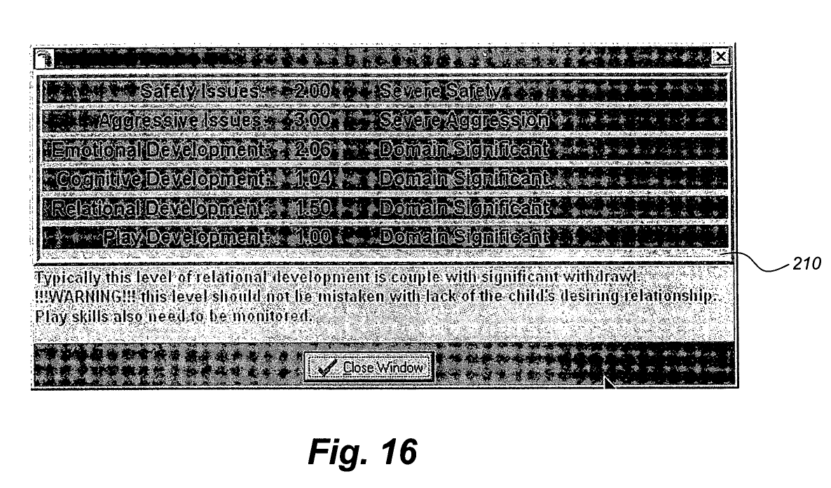

FIG. 13 shows an alternate Global Domain Graph page using column charts 204 instead of histograms 40, and a list box 206 with an appropriate summary of notable issues and characteristics affecting treatment for the levels. The Global Domain Graph page is accessed by clicking the Global sub-folder tab 208 in the Assessments folder. FIG. 16 shows a dialog box containing computed numerical mean values for the Safety and Aggressiveness Issues, as well as the other four core domain development factors, together with a list box 210 summarizing the significance of the mean values. Also contained within the Assessment folder are pages of computed means values for different sub-levels within the core domains, as derived from the values entered in the strengths and questions folders. FIG. 14 shows an exemplary page of computed mean values for the various sub-levels of Emotional Development. This page is viewed by clicking on the Emotional sub-folder 212 under the Assessment folder tab. Similar pages are provided for the Cognitive Development, Relational-Social, and Play Development domains, which are accessed by clicking the appropriate sub-folder tabs.

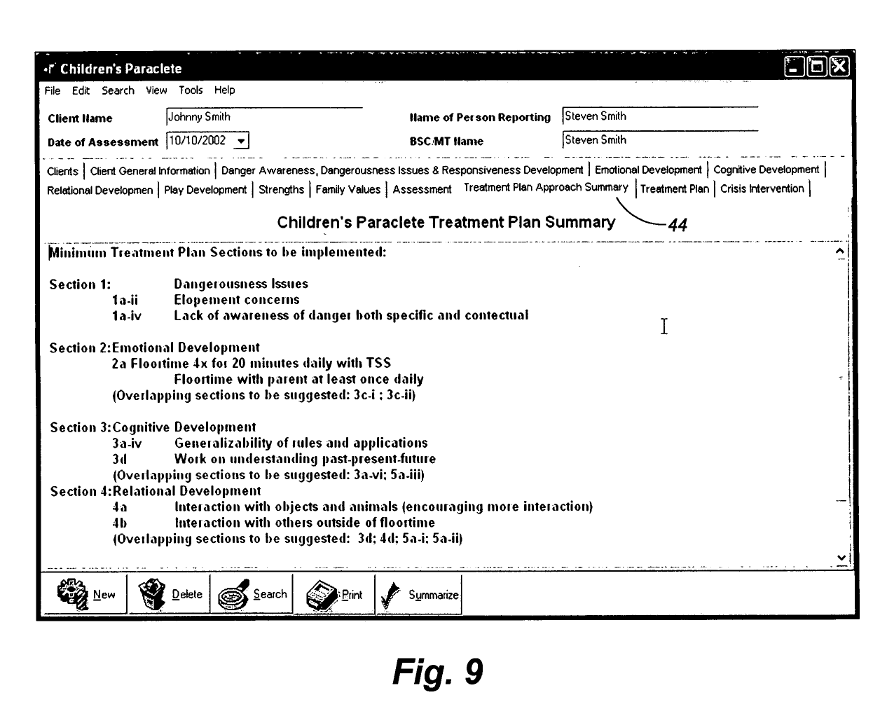

FIG. 9 shows a screen shot of the Treatment Plan Approach Summary folder page 44. The folder page 44 displays minimum sections of a treatment plan which must be addressed according to the information provided in the core domain sections. Generally, scores showing lower competency in a particular domain will result in suggested treatment plan sections emphasizing more basic skills, while scores showing higher competency result in treatment plan sections emphasizing more complex skills.

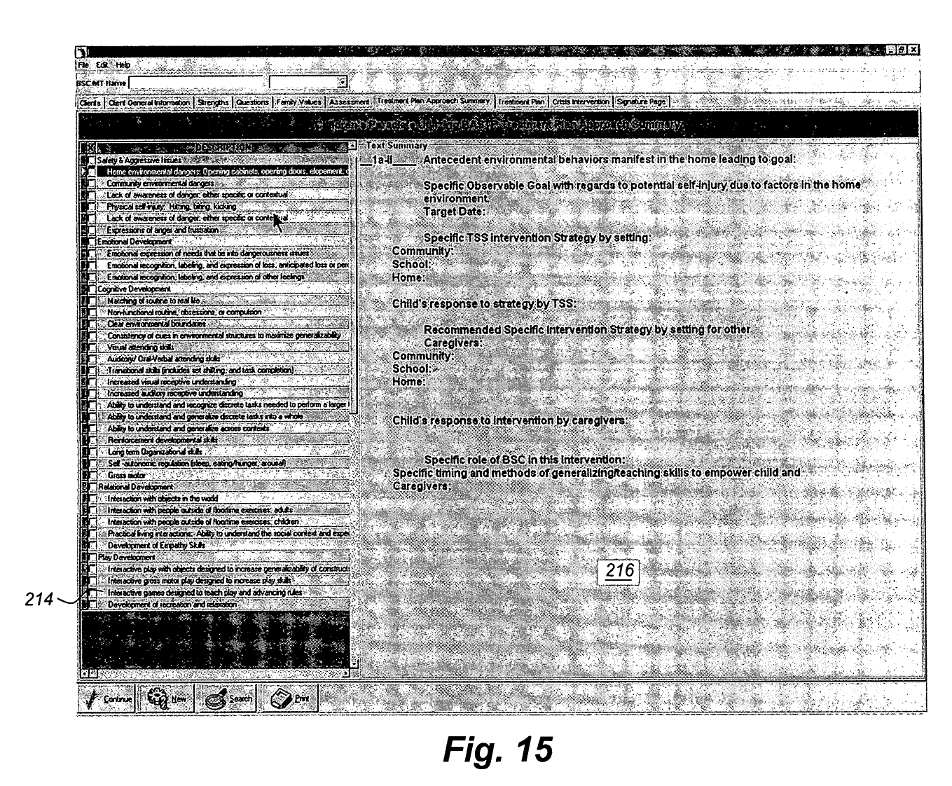

FIG. 15 shows an alternate Treatment Plan Approach Summary page. In this embodiment the left side of the screen contains a scrollable list 214 of checkboxes of significant factors related to the safety and aggressiveness issues and the core domain that may need to be addressed in the treatment plan. The appropriate checkboxes may be automatically checked by the program based upon the strengths and questions forms filled out by the BSC, and may also be edited by the therapist reviewing the treatment summary. The right side of the screen contains a list box or edit box 216 with a standard framework that needs to be addressed in the treatment plan, and may have standard recommendations or cautions supplied by the program based upon which checkboxes are checked.

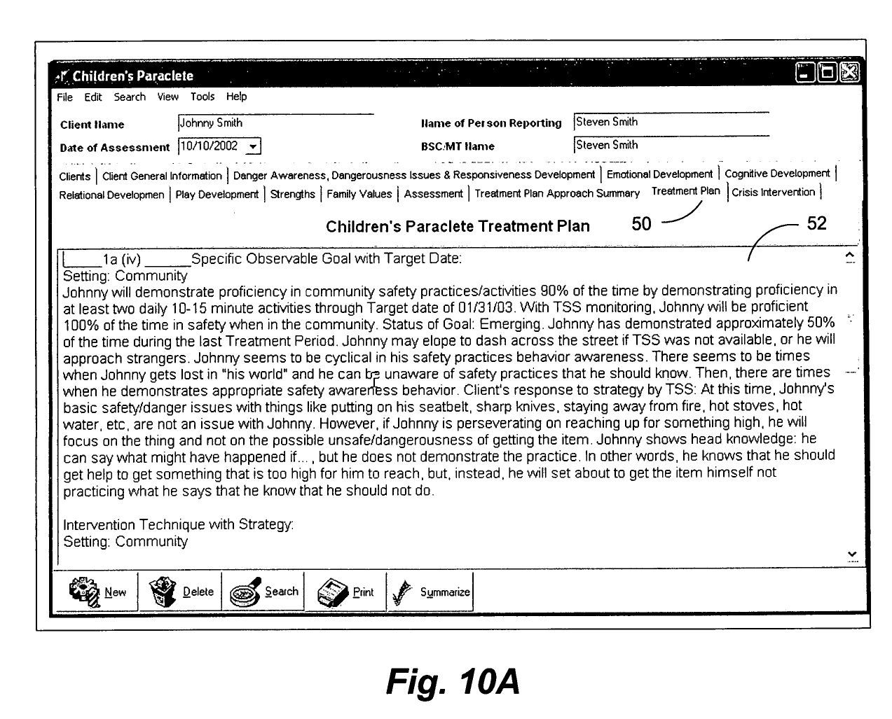

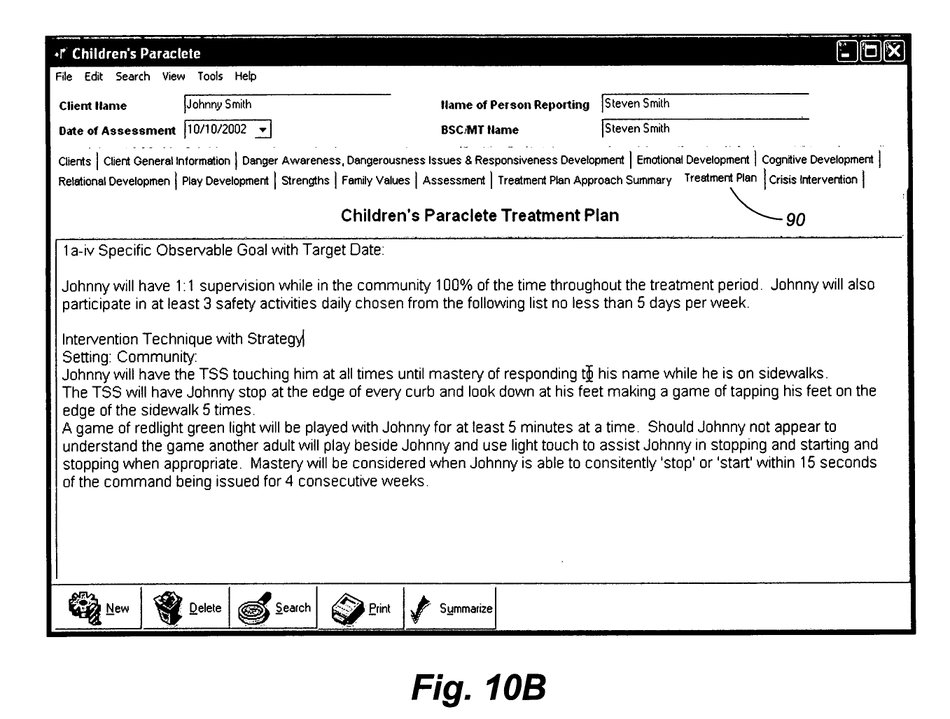

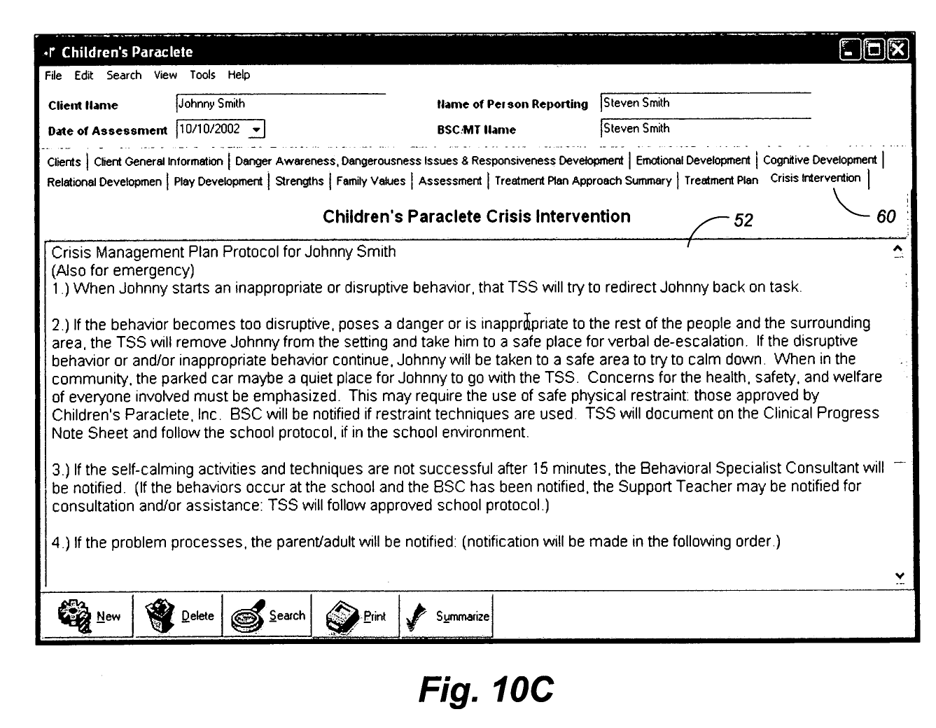

FIGS. 10A, 10B and 10C show screen shots of the Treatment Plan folder 50 page and Crisis Intervention folder 60 page, respectively. Each folder page 50 and 60 has an edit box 52 having sufficient space to textually disclose a treatment plan. The computer program computes the average developmental levels of each domain ranging from a low of level 0 (no competency) to a high of level 5 (highly competent). The levels are generally an average score of the results from the assessment device relating to that domain.

The computer then outputs, based on the relative strengths of the core domains, a suggested percentage of treatment time to be allocated to each of the five domain areas. Ordinarily domains with lower scores will be allocated larger percentages of time. The computer then outputs several suggested strengths the patient has which have been helpful in treating similarly situated individuals in the past. For each treatment issue mentioned above the computer would output related dangerous issues, difficulties which the patient, according to his profile, may have overcoming the treatment issue, and any related strengths which may be helpful in overcoming the treatment issue. Finally, the computer would output several suggested treatment methods that have been used in similar circumstances in the past.

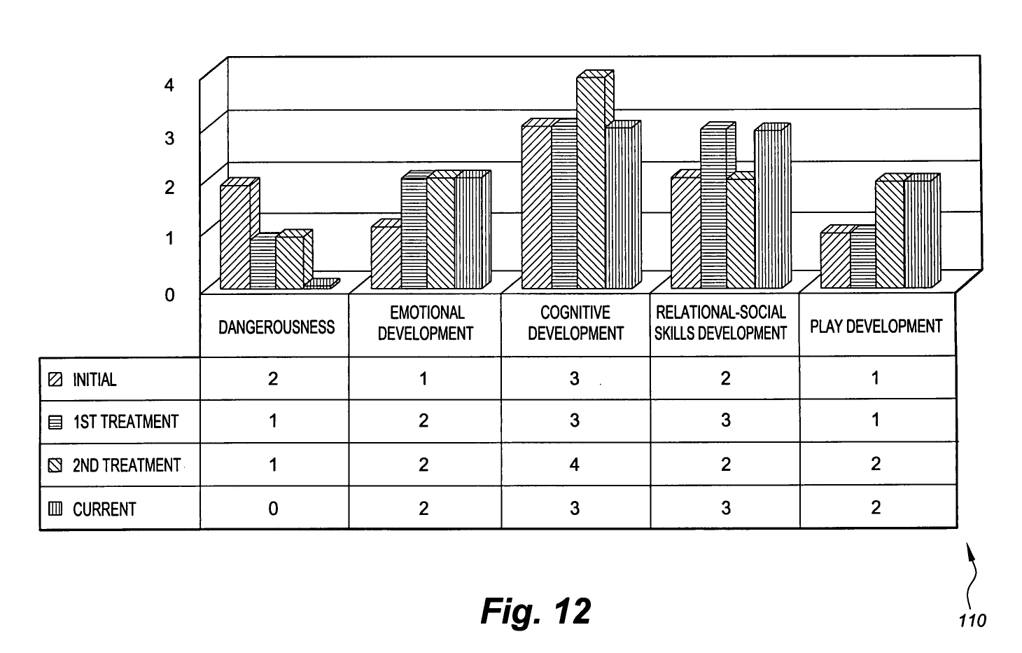

An exemplary treatment plan as generated by the computer might appear as shown in FIG. 10A. The BSC then has the option of entering additions or modifications to the treatment plan, as shown in FIG. 10B. The process is repeated for each treatment issue and for any additional treatment issues the BSC sees fit to address. After a period of treatment, the entire assessment process is repeated. After three repetitions the computer will output a progression graph 110 such as that shown in FIG. 12 showing the progression of the patient over time throughout the five core domains.

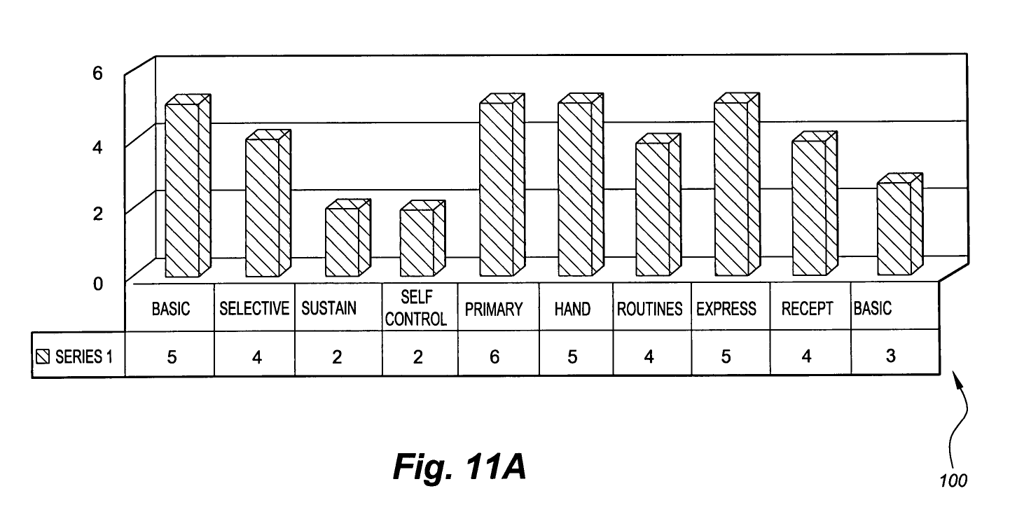

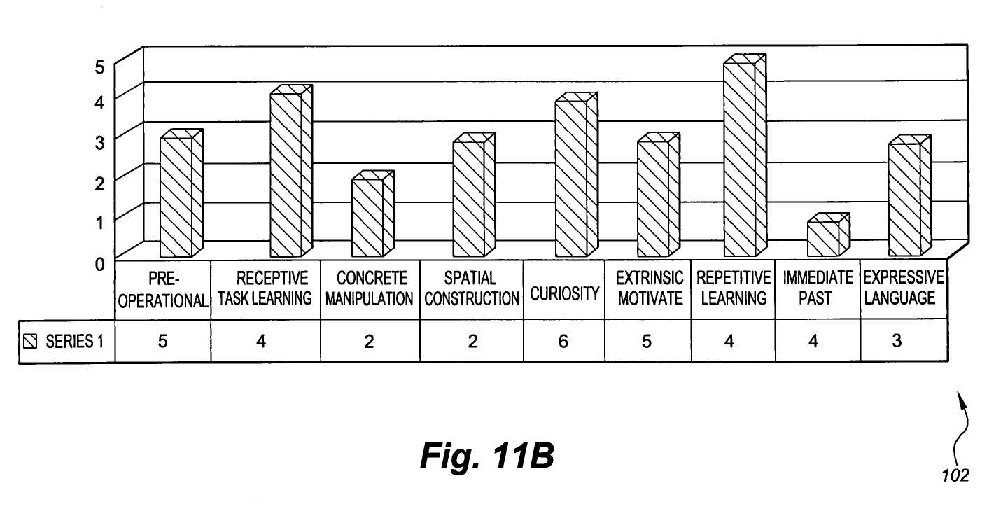

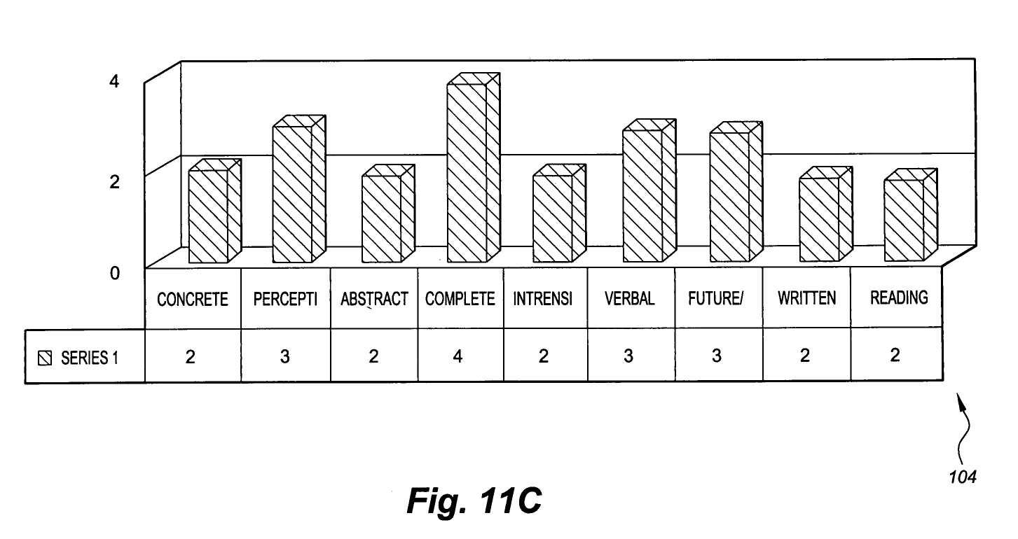

Next, based on the abovementioned assessment devices, the computer outputs individual analyses for each of the five domains and their corresponding developmental levels. Each assessment question is related to one or more sub-levels, as well as to the core domain levels. The computer uses the answers from each question to break down each core domain developmental level into sub-levels and graphically depicts the development progress for each sub-level. For example, for a patient with a cognitive level of 3, the computer would output three graphs 100, 102, and 104, as shown in FIGS. 11A, 11B and 11C detailing the sub-levels 1, 2 and 3, respectively, for each core domain developmental level. The sub-levels for each core domain developmental level are as follows:

Emotional Development

Level 1

Self-awareness

Awareness of others

Physical antecedents of emotions

Primitive self-soothing

Physical expressions of positive emotions

Physical expressions of negative emotions

Level 2

Awareness of basic emotional interplay v. self-absorption

Intermediate awareness of self

Intermediate awareness of other

Antecedents of behaviorally expressed emotions identified

Basic self-soothing

Physical expressions of positive emotions identified

Physical expressions of negative emotions identified

Level 3

Awareness of looking to others for emotional recognition

Antecedents of behaviorally expressed emotions anticipated/predicted

Physical expressions of positive emotions labeled

Physical expressions of negative emotions labeled

Basic mood stability established

Level 4

Awareness of others' emotional needs

Basic positive emotions expressed verbally

Basic negative emotions expressed verbally

Expressions of emotions invite reciprocity

Expressions of emotions invite release/fulfillment

Mood stability established

Level 5

Reciprocity of emotional needs expressed in dialogue

Advanced positive emotions expressed verbally

Advanced negative emotions expressed verbally

Emotional empathy relates to theory of mind

Relational Development

Level 1

Self-awareness

Awareness of others

Cries/laughs with others

Awareness

Eye contact

Object interactive play

Part object play

Reaches out to be picked up or hugged

Hugs back

Level 2

Parallel play

Expanded object play

Play with adults primarily with modeling

Play with parents primarily with modeling

Peer conversation

Whole object play

Able to gain basic comfort from others

Level 3

Child is able to maintain topic of their choosing

Awareness of looking to others for emotional recognition

Ability to label feelings in social stories/movies

Basic understanding of rules based on punishment or reward

Basic mood stability

Level 4

Ability to identify feelings in others

Ability to answer basic relational drama thematic questions

Ability to answer basic How, Why, questions in regards to relationships

Understands social flow

Understands communication flow

Patient is able to maintain conversation topic of other=s choosing

Judgment based on authority

Level 5

Able to answer intermediate to advanced How, Why questions in regards to relationships

Patient is able to read contexts of situations

Understands rules and judgment based on social contexts

Play Development

Level 1

Part-object play

Self-stemming play

Single toy with little elaboration

Self pretend

Level 2

Plays with multiple toys with limited interaction through modeling

Plays with a variety of toys

Basic pretend with others generally adults

Basic turn taking with adults

Basic parallel play

Gross motor interactive play

Level 3

Child is able to initiate play with adult

Child is able to engage in turn taking limited play with peers

Wider elaboration of imaginative play with objects

Play sequence tells a basic story

Level 4

Interactive play combining themes and imagination

Child spontaneously seeks play with adults

Child willingly participates with children in play

Child is able to play games with an understanding of rules

Level 5

Play that is rich in problem solving

Interactive play that shows a broad understanding of rules and applications

Spontaneous play

Cognitive Development

Level 1

Basic attention concentration

Selective attention

Sustained focused concentration

Self control

Internal Curiosity

Primary reinforcers

Hand over hand instruction

Awareness of routine

Level 2

Preoperational thinking

Receptive learning from a task

Intentional concrete manipulation

Spatial construction from pictures

External curiosity

Extrinsic motivation

Rote repetitive learning

Understanding of immediate past

Level 3

Concrete operational thinking

Perception/reality testing

Basic abstract Manipulation

Complex interrelated Spatial designs

Intrinsic motivation

Verbal instruction

Understanding of Future

Understanding of past

Level 4

Formal operational thinking

Representational abstract manipulation

Delayed gratification

Learning through extrapolation

Goal planning

Level 5

Interdependence

It will be noted that numerical summaries of these sub-levels may be accesses in the Assessment folder by clicking the appropriate sub-folder tab, such as the Emotional sub-folder tab 212 shown in FIG. 14.

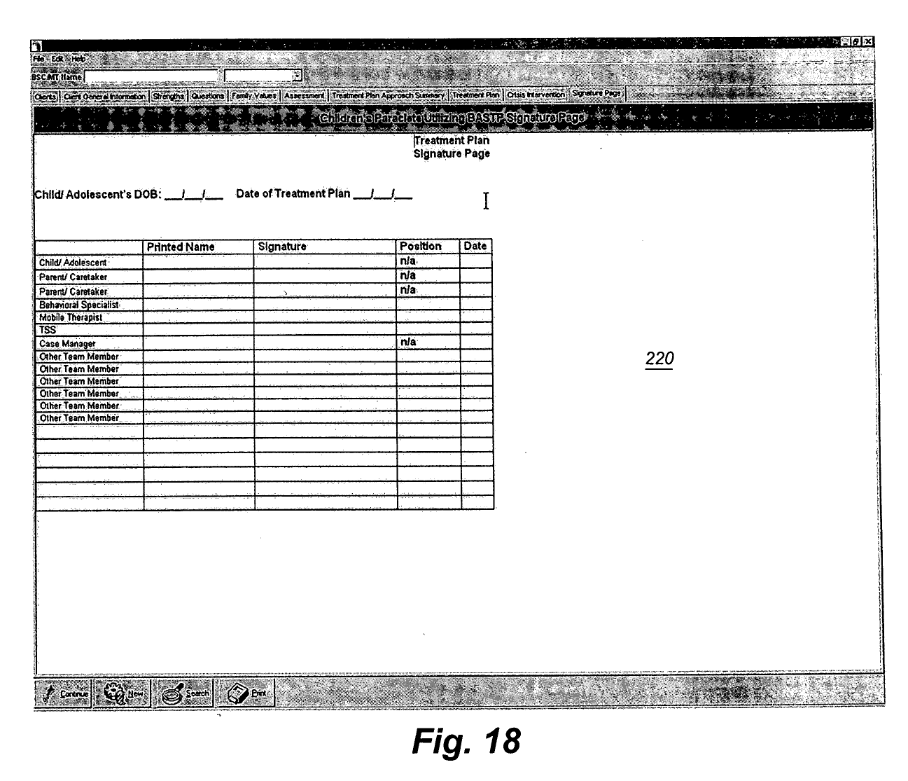

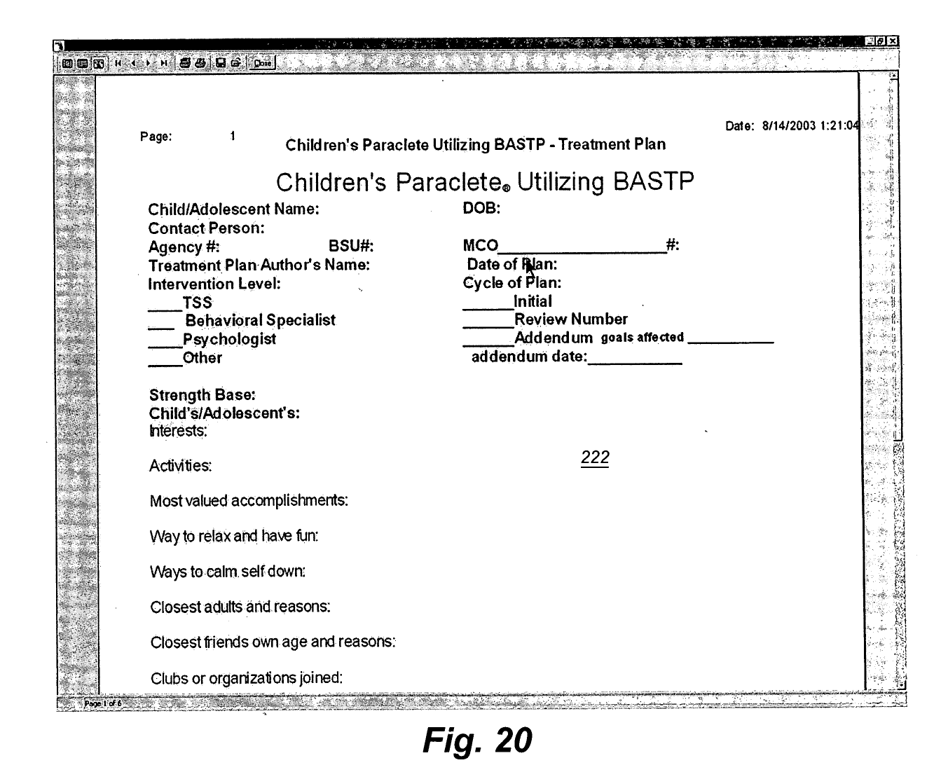

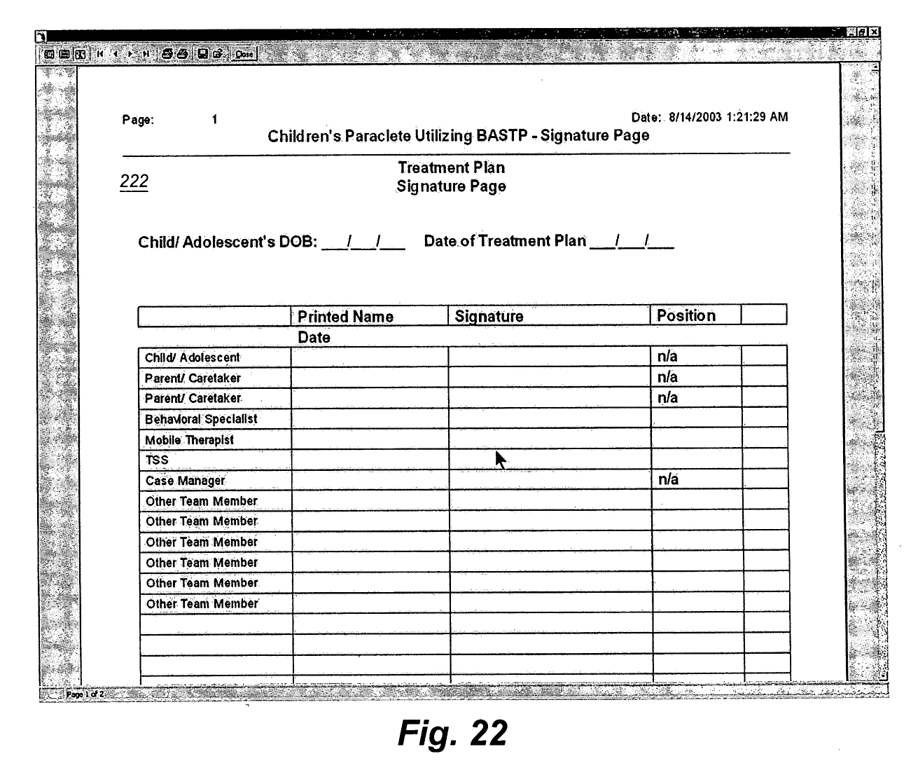

A print preview version 218 of an alternative format treatment plan is shown in FIG. 20. Once again, the program generates a basic form with issues to be addressed by the treatment plan, and may generate recommended treatment approaches based upon previous clients with similar profiles. The treatment plan, however, should be edited by the user, as appropriate. The program includes a signature page that can be edited by the user which is accessible through the Signature Page folder tab 220, as shown in FIG. 18, of which a print preview version 222 is shown in FIG. 22.

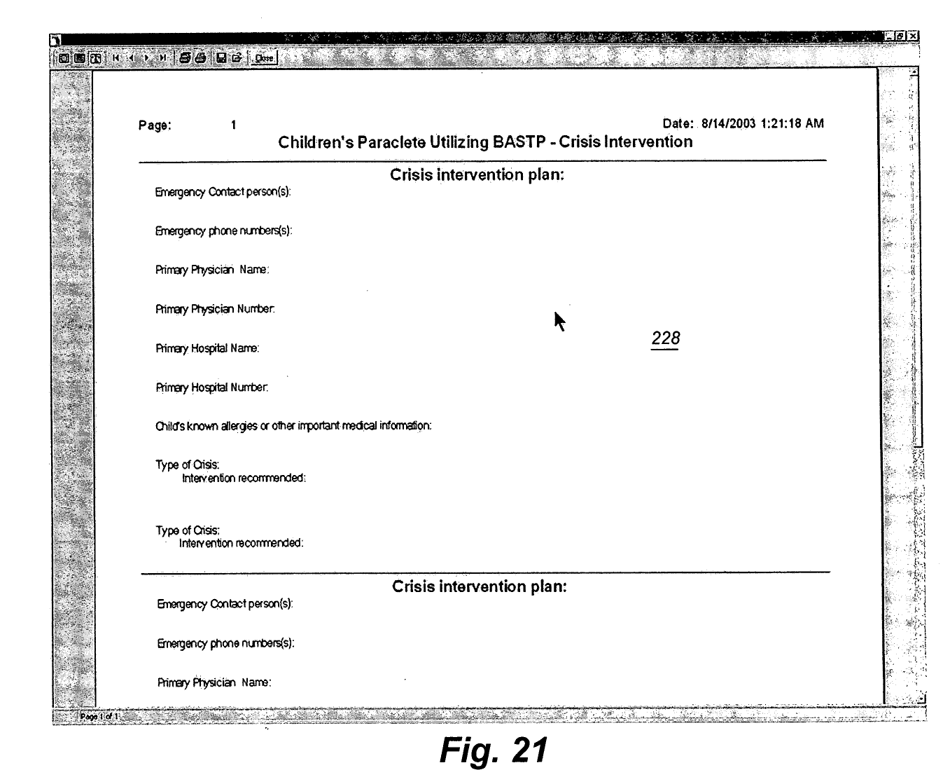

An alternate crisis intervention plan can be created using the Crisis Intervention folder tab 224 to access a crisis intervention plan page 226 which can be edited. A print preview version 228 of the crisis intervention plan is shown in FIG. 21.

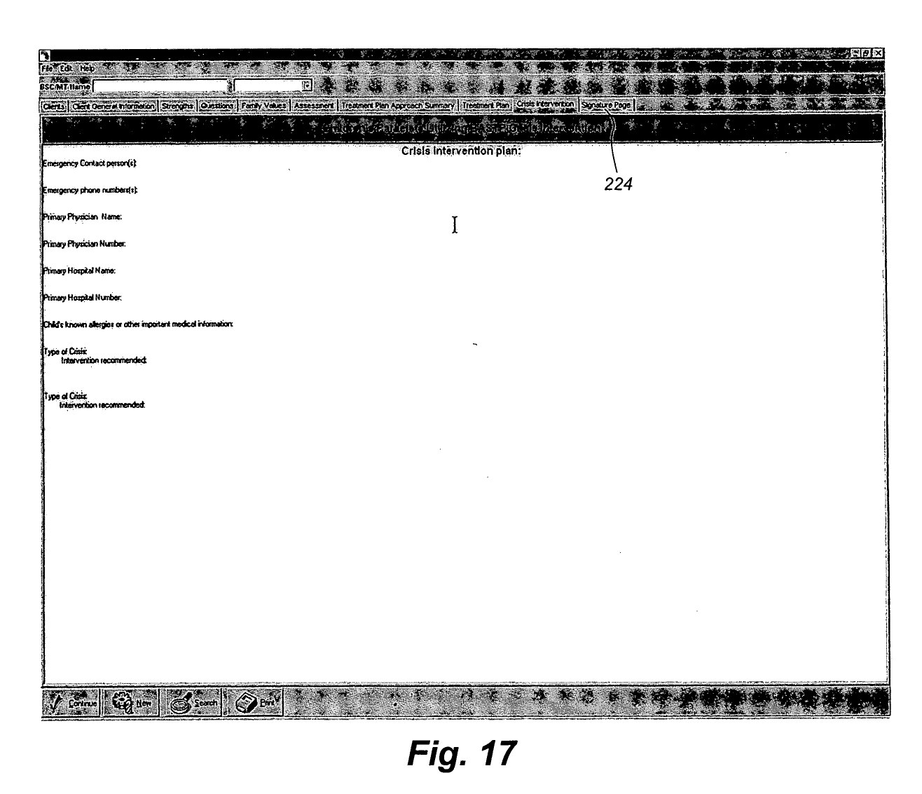

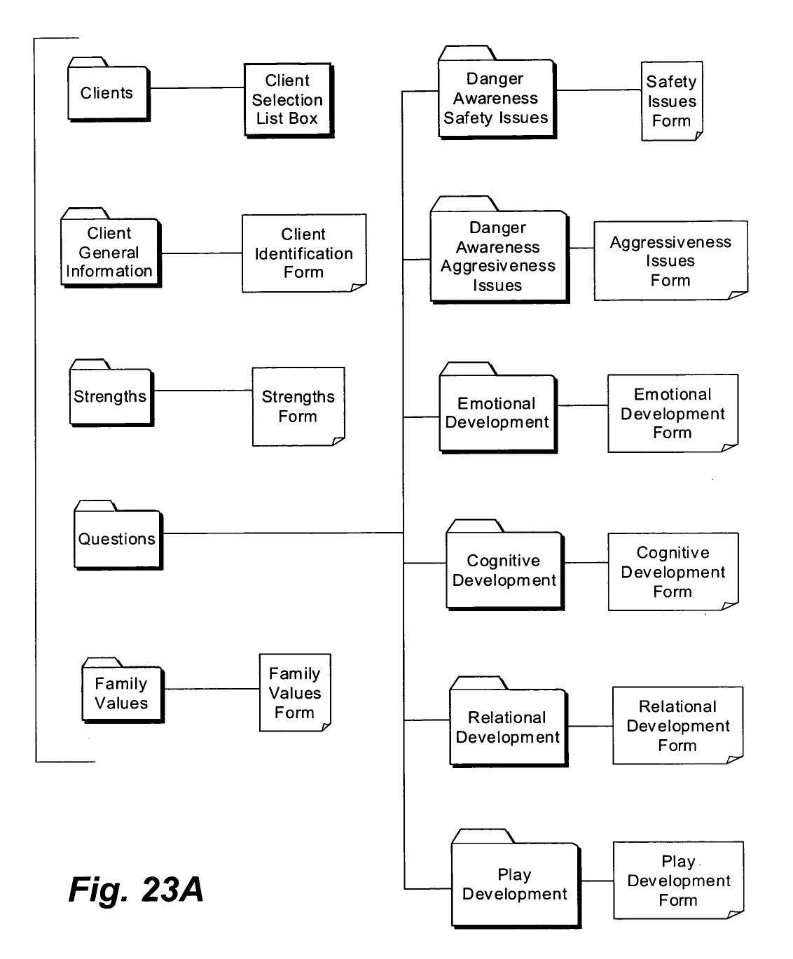

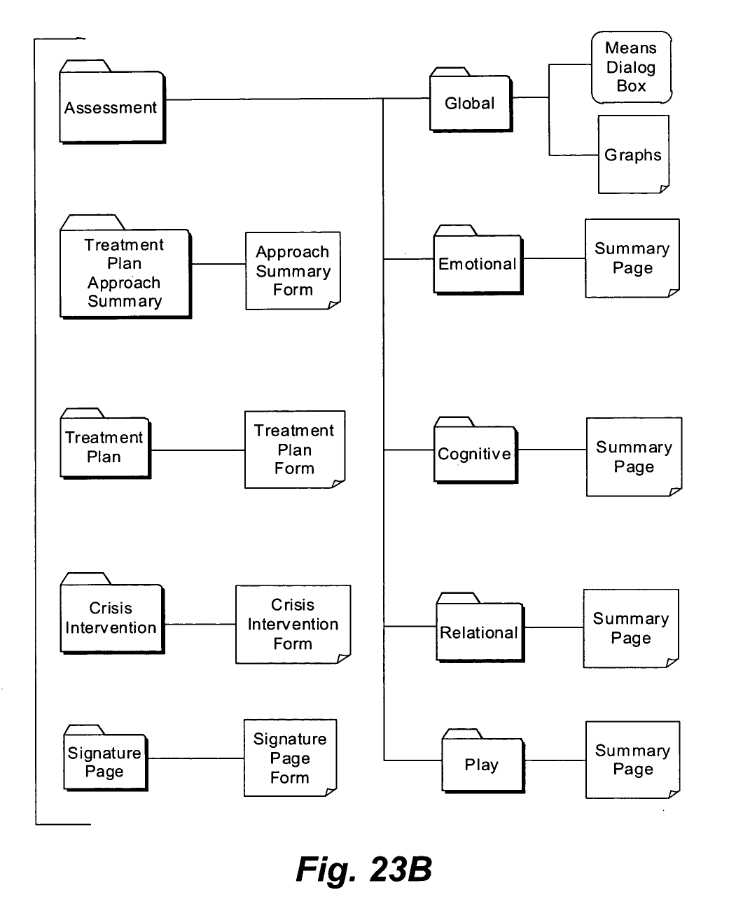

FIGS. 23A and 23B provide a chart summarizing access to the various data entry pages or forms, and to the output reports. The chart in FIGS. 23A and 23B are based on the user interface exemplified in the screen shots of FIGS. 13-22. A chart for the user interface exemplified in FIGS. 2-9 would be similar, except that the Questions folder tab would be replaced by primary folder tabs for the Danger Awareness categories, including Safety Issues and Aggressiveness Issues in sub-folders, and for the remaining four core domains (Emotional, Cognitive, Relational, and Play Development). The folders shown in FIG. 23A generally relate to accessing the forms where the BSC enters his or her evaluations of the issues and factors called for by the developmental treatment method of the present invention. The folders shown in FIG. 23B generally relate to plans, graphs, warnings, and reports which are partially generated by the software program based upon the BSC evaluations, and which should be edited by the therapist to tailor the treatment plan to the individual patient in light of the therapist's judgment. The forgoing organization of the user interface should be obvious in light of the screen shots discussed above, and will not be described further.

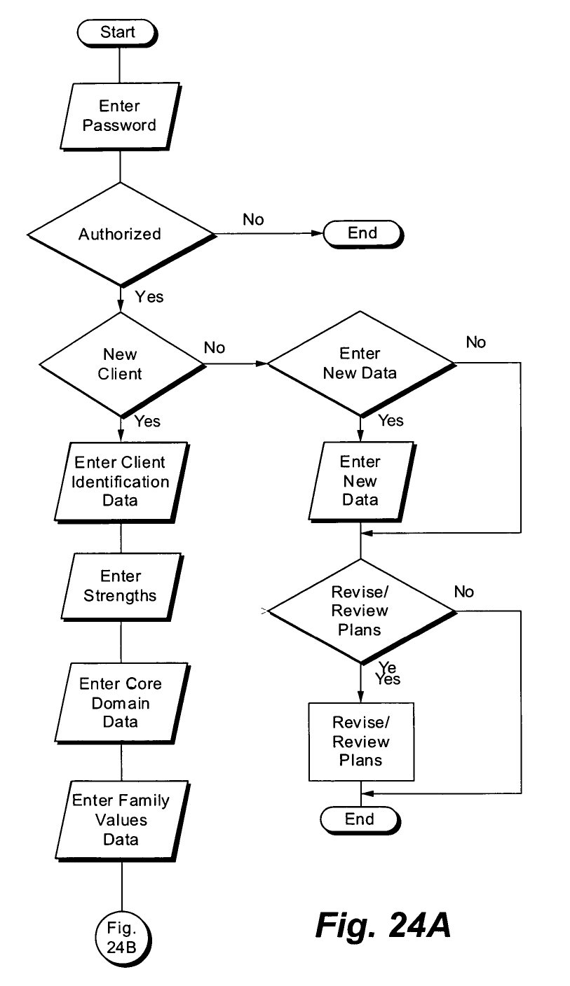

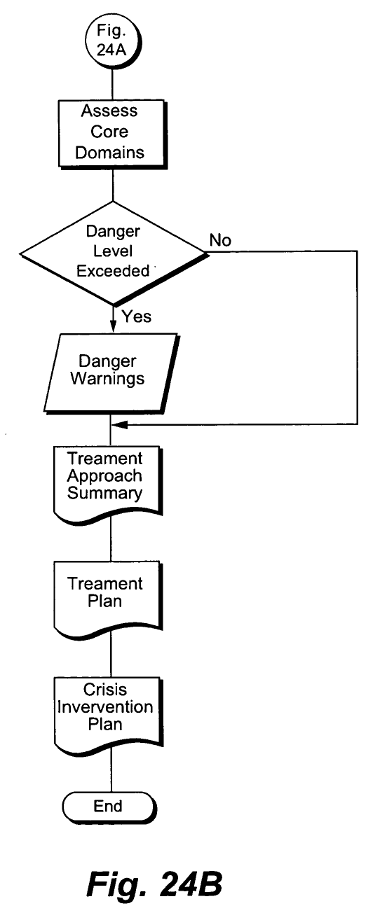

FIGS. 24A and 24B show a flow chart describing the operation of the software program. The user enters his or her password. If the user is authorized, the user may then either opt to enter a new client or patient into the records maintained by the program, or to open the folder of a client previously entered into the program records. The latter option is available to enter new data or modify old data, or to revise and review the treatment plan or crisis intervention plan. In any event, the course of treatment of an autistic patient always requires periodic review of the assessment of the patient and the progress of the treatment plan.

When a new client is entered into the system, the user enters client identification data, records the evaluation of the patient's strengths, records the evaluation of the core domain data (safety and aggressiveness issues, and emotional, cognitive, relational, and play development), and the family values data. The user can then assess the core domains. The software calculates mean values based upon the data. If the danger awareness assessments exceed or fall below predetermined limits, the software generates a dialog box including warnings of behavior or traits which merit particular observation or attention in the treatment plan. The software will always calculate mean values to assess the core domain factors. The user may then access the treatment plan approach summary and the treatment plan, which may include recommended courses of treatment by comparison to previous patients with similar profiles, or by reference to expert opinion. The treatment plan approach summary and the treatment plan itself will always require editing to adapt the plan to the individual patient, but the program directs the users attention to the appropriate issues that need to be addressed and to useful recommendations for treatment. The crisis intervention plan can also be accessed for entry of appropriate information in light of the risks apparent from the assessment data. The plans may be printed out, together with an appropriate signature page to indicate which members of the treatment team have prepared and/or reviewed the plans.

It will be seen that the software program of the present invention is well adapted for use by a treatment team. The program provides a comprehensive list of factors requiring evaluation for the development of a developmental treatment plan for autistic patients. After entry of the appropriate data, the program provides a calculated assessment of the patient's strengths and weaknesses, alerts the user to issues presenting a danger to the patient or others, and assists in preparing and recording a treatment and crisis intervention plan. The records may be periodically reviewed and updated to verify that the treatment plan is still appropriate and is on course. The system and method of the present invention therefore provides a valuable adjunct for the treatment of the autistic patient.

It is to be understood that the present invention is not limited to the embodiment described above, but encompasses any and all embodiments within the scope of the following claims.

I claim:

1. A computer program product that includes a medium readable by a processor, the medium having stored thereon a set of instructions for an autism treatment system, comprising:
(a) a first sequence of instructions which, when executed by the processor, causes the processor to request patient information for an autistic patient from a user, and then to record the information entered by the user;
(b) a second sequence of instructions which, when executed by the processor, causes said processor to output a plurality of assessment forms having a checklist of patient signs and symptoms, and to receive and record numerical ranking information input by the user relating to each of the signs and symptoms for each the assessment forms;
(c) a third sequence of instructions which, when executed by the processor, causes the processor to compile and output a graphical representation of each the assessment forms; and
(d) a fourth sequence of instructions which, when executed by the processor, causes the processor to evaluate the numerical ranking of each of the signs and symptoms, and to output critical treatment issues and suggested treatment methods for the treatment issues based on the evaluation of the numerical rankings.

2. The computer program product according to claim 1, wherein said assessment forms further comprise a checklist of behaviors and observations related to the autistic patient's strengths.

3. The computer program product according to claim 1, wherein said assessment forms further comprise a checklist of signs and symptoms related to a plurality of core domains, one of the core domains being danger awareness, including safety issues and aggressiveness issues.

4. The computer program product according to claim 3, wherein said core domains includes signs and symptoms related to emotional development.

5. The computer program product according to claim 3, wherein said core domains includes signs and symptoms related to cognitive development.

6. The computer program product according to claim 3, wherein said core domains includes signs and symptoms related to relational and social development.

7. The computer program product according to claim 3, wherein said core domains includes signs and symptoms related to play development.

8. The computer program product according to claim 1, further comprising a fifth sequence of instructions which, when executed by the processor, causes the processor to record information relating to the autistic patient's family values.

9. The computer program product according to claim 1, wherein said second sequence of instructions includes a checklist of patient signs and symptoms relating to danger awareness encompassing safety issues and aggressiveness issues, the computer program product further comprising a sixth sequence of instructions which, when executed by the processor, causes the processor to calculate mean numerical values for the danger awareness signs and symptoms, and to output warnings related to dangers when the mean numerical values exceed threshold values.

10. A computerized method for developing a treatment plan for an autistic patient, comprising the steps of:
(a) evaluating and recording the autistic patient's strengths, including assigning a numerical ranking to each strength;
(b) evaluating and recording the autistic patient's signs and symptoms in a plurality of core domains of developmental areas, including assigning a numerical ranking to each of the signs and symptoms;
(c) generating and recording an assessment of the patient's median numerical ranking for each of the core domains;
(d) generating and recording a treatment plan template addressing critical treatment issues based upon the median numerical ranking of the core domains;
(e) editing the treatment plan template to formulate a treatment plan; and
(f) treating the autistic patient in accordance with the treatment plan.

11. The computerized method according to claim 10, wherein said step of evaluating strengths further comprising evaluating all strengths listed on a checklist of strengths.

12. The computerized method according to claim 10, wherein said core domains comprise danger awareness signs and symptoms, including a checklist of safety issues and a checklist of aggressiveness issues.

13. The computerized method according to claim 10, wherein said core domains comprise signs and symptoms related to emotional, cognitive, relational and social, and play development.

14. The computerized method according to claim 10, further comprising the steps of periodically updating step (b), (c) and (d).

15. The computerized method according to claim 10, further comprising the steps of recording the autistic patient's family values and revising the treatment plan in light of the family values.

16. The computerized method according to claim 10, further comprising the step of formulating and recording a crisis intervention plan.

17. An autism treatment system, comprising:
(a) at least one computer having a processor, an area of main memory for executing program code under the direction of said processor, a storage device for storing data and program code, and a bus connecting the processor main memory and the storage device;
(b) at least one relational database stored on said storage device;
(c) a computer program code stored in said storage device and executing in main memory under the direction of said processor, the computer program including:
(i) means for requesting patient information from a user and recording the information;
(ii) means for displaying a plurality of assessment forms having a checklist of patient signs and symptoms, and for receiving numerical ranking information input by a user relating to each of the signs and symptoms for each the assessment forms;
(iii) means for compiling and outputting a graphical representation of said assessment forms; and
(iv) means for evaluating the numerical ranking of each of the signs and symptoms, and for outputting critical treatment issues and suggested treatment methods for the treatment issues based on the evaluation of the numerical rankings.
